(19) United States
(12) Patent Application Publication
(10) Pub. No.: US 2026/0365514 A1
(43) Pub. Date: Nov. 19, 2026

(54) METHOD FOR SYNTHESIZING HYDROGEN PEROXIDE UNDER MILD CONDITIONS

(71) Applicant: Jiangsu Univeristy, Zhenjiang (CN)

(72) Inventors: Shun Li, Zhenjiang (CN); Xinyue Zhang, Zhenjiang (CN); Jianming Zhang, Zhenjiang (CN)

(21) Appl. No.: 19/366,871

(22) Filed: Oct. 23, 2025

(30) Foreign Application Priority Data
May 16, 2025 (CN) 2025106346552

(51) Int. Cl. C01B 15/027; B01J 27/04; B01J 27/057; B01J 37/00; B01J 37/04; B01J 37/08; B01J 37/34

(52) U.S. Cl. CPC C01B 15/027; B01J 27/04; B01J 27/0573; B01J 27/0576; B01J 37/009; B01J 37/04; B01J 37/08; B01J 37/343

(57) ABSTRACT

A method for synthesizing hydrogen peroxide under mild conditions is provided. This method uses oxygen and water as raw materials and employs a defect-rich group Ⅳ-Ⅵ binary semiconductor material as a catalyst. Without the need for additional energy input (such as light or electric field) and without the need for sacrificial agents, this method can achieve efficient, safe, and low-cost hydrogen peroxide synthesis through thermal catalysis under mild conditions. This method is simple to operate, low in energy consumption, and environmentally friendly. It fills the technical gap in synthesizing hydrogen peroxide from water and oxygen under mild conditions and has important prospects for industrial application.

### CROSS-REFERENCE TO RELATED APPLICATION

This application claims priority to Chinese Patent Application No.202510634655.2, filed on May 16, 2025, which is herein incorporated by reference in its entirety.

### TECHNICAL FIELD

The disclosure relates to the field of hydrogen peroxide preparation, specifically relates to a method for synthesizing hydrogen peroxide under mild conditions, and more particularly to a method for synthesizing hydrogen peroxide by using oxygen and water as raw materials and a defect-rich group Ⅳ-Ⅵ binary semiconductor material as a catalyst.

### BACKGROUND

Hydrogen peroxide is an important chemical with a wide range of applications, and its synthesis technology has always been a key focus in the field of chemical engineering. Traditional industrial hydrogen peroxide synthesis mainly relies on an anthraquinone method. The anthraquinone method uses anthraquinone as a carrier and a palladium-based catalyst, and alternates between hydrogenation and oxidation reactions to prepare hydrogen peroxide. However, the anthraquinone method has several significant drawbacks. On one hand, this process is relatively complex, involving multiple reaction steps and complicated separation and purification operations, which lead to high equipment investment costs. On the other hand, this process requires stringent reaction conditions, necessitating precise control of temperature, pressure, and reactant concentrations. Moreover, this process is energy-intensive and generates a large amount of organic waste.

In recent years, researchers have been committed to developing more environmentally friendly, efficient, and low-cost methods for synthesizing hydrogen peroxide. Among these, a direct synthesis method, which can directly catalyze a reaction of hydrogen and oxygen to produce hydrogen peroxide, has attracted widespread attention using noble metals such as palladium and gold as active components. This method simplifies the reaction process and reduces energy consumption. However, the cost of the noble metal catalyst is high, and the use of flammable and explosive hydrogen gas as a raw material is required. In addition, in recent years, photocatalytic and electrocatalytic methods have also provided very promising green reaction pathways, which can achieve the synthesis of hydrogen peroxide from oxygen and water, and are considered the most promising potential green synthesis methods for the future. However, these methods require additional external energy input (such as light energy, electrical energy, etc.), which increases energy consumption, and the catalysts are relatively complex and expensive, limiting their large-scale application.

### SUMMARY

Based on the existing problems, the disclosure provides a method for synthesizing hydrogen peroxide with features of mild reaction conditions, safety, environmental friendliness, and low cost. Using oxygen and water as raw materials and a defect-rich group Ⅳ-Ⅵ binary semiconductor material as a catalyst, the synthesis of hydrogen peroxide can be achieved at ambient temperature and pressure without the need for additional energy input, and without the use of hydrogen gas, sacrificial agents, or the like, thus offering a green, safe, and low-cost synthetic route.

The disclosure provides a method for synthesizing hydrogen peroxide under mild conditions, which includes:
dispersing a defect-rich group Ⅳ-Ⅵ binary semiconductor material as a catalyst in water, followed by stirring or ultrasonic dispersion, and the continuously introducing air or oxygen into the water to undergo a reaction at a constant temperature in a range of 0 to 80℃, thereby catalytically producing hydrogen peroxide.

In an embodiment, the defect-rich group IV-VI binary semiconductor material is one selected from the group consisting of Sn₁₋ₓSe, Sn₁₋ₓTe, Sn₁₋ₓS, Ge₁₋ₓTe, Ge₁₋ₓSe, Ge₁₋ₓS, Pb₁₋ₓSe, Pb₁₋ₓS, and Pb₁₋ₓTe, the x value is 0 to 0.99. Specifically, Sn is tin, Se is selenium, Te is tellurium, S is sulfur, Ge is germanium, and Pb is lead.

In an embodiment, a morphology of the catalyst is one or more of platelets, wires, particles, or porous structures, a size of the catalyst is in a range of 10 nanometers (nm) to 100 micrometers (µm), and a porosity of the catalyst is in a range of 0 to 60%.

In an embodiment, a usage ratio of the catalyst to the water is (10 milligrams (mg)-1 gram (g)) : 1 liter (L).

In an embodiment, the constant temperature of the reaction is in a range of 20°C to 50°C.

In an embodiment, an atmosphere is the air or the oxygen.

In an embodiment, the water includes deionized water, seawater, domestic water, or natural water.

The disclosure may achieve the following beneficial effects.

The disclosure provides a completely new method for synthesizing hydrogen peroxide under mild conditions. Compared to all existing hydrogen peroxide production processes, a process of this method is characterized by mild reaction conditions and a simple operating procedure. It is a safe, green, low-energy, and low-cost method for producing hydrogen peroxide, with the following specific advantages: (1) Green and environmentally friendly, no additional energy or sacrificial agents required; (2) Simple operation, suitable for a variety of environmental conditions; (3) Low cost, no need for noble metals, the catalyst can be regenerated and commercialized; (4) Flexible method, with a wide range of product applications.

### BRIEF DESCRIPTION OF DRAWINGS

FIG. 1 illustrates a schematic diagram of morphology images of Sn₁₋ₓS catalysts. Specifically, in FIG. 1, a represents a morphology image of a SnS catalyst, b represents a morphology image of a Sn_{0.9}S catalyst, c represents a morphology image of a Sn_{0.8}S catalyst, and d represents a morphology image of a Sn_{0.7}S catalyst.

FIG. 2 illustrates a schematic diagram of catalytic performance comparison of the Sn₁₋ₓS catalysts.

FIG. 3 illustrates a schematic diagram of catalytic performance of the Sn_{0.8}S catalyst at different reaction temperatures.

FIG. 4 illustrates a schematic diagram of catalytic performance comparison of different defect-rich group Ⅳ-Ⅵ binary semiconductor catalysts.

### DETAILED DESCRIPTION OF EMBODIMENTS

In order to make objectives, technical solutions, and advantages of the disclosure clearer, a further detailed description of the disclosure will be provided below.

The disclosure provides a method for synthesizing hydrogen peroxide under mild conditions. This method uses water and oxygen as reaction raw materials and a defect-rich group Ⅳ-Ⅵ binary semiconductor material as a catalyst to undergo a catalytic reaction at room temperature, thereby synthesizing hydrogen peroxide.

The technical solution of the disclosure will be described in detail below in conjunction with embodiments. However, the scope of the disclosure is not limited to the embodiments described below.

Based on the embodiments of the disclosure, all other embodiments obtained by those skilled in the art without making any inventive effort are within the scope of protection of the disclosure.

### Embodiment 1

### 1. Synthesis of Sn₁₋ₓS catalysts by a hot-injection method

Specifically, 0.2 millimoles (mmol) of sulfur powder is dispersed in 3 milliliters (mL) of oleylamine, and then is subjected to ultrasonic treatment for 10 minutes to ensure uniform dispersion of the sulfur powder, forming a sulfur precursor solution. Then, 0.2 mmol of tin (II) chloride dihydrate (SnCl₂·2H₂O) is dissolved in 5 mL of oleylamine in a three-neck flask with stirring at 60°C for 30 minutes until completely dissolved to obtain a uniform solution. Then, this uniform solution is degassed and purged with nitrogen for 1 hour to remove dissolved oxygen, obtaining a Sn precursor solution. The Sn precursor solution is heated to 180°C at a rate of 5°C per minute (°C/min) and maintained at this temperature for 10 minutes. Subsequently, the sulfur precursor solution is rapidly injected into the Sn precursor solution in the three-neck flask by using a syringe to obtain a mixed solution. After the mixed solution turns black, the mixed solution is kept at a constant temperature (i.e., 180°C) for 1 hour under a nitrogen atmosphere, then is cooled to room temperature, and the resulting black powder SnS is collected.

Based on the above designated stoichiometric ratio, an amount of stannous chloride (SnCl₂) is adjusted to 0.18 mmol according to the above same steps to synthesize Sn_{0.9}S catalyst.

The amount of SnCl₂ is adjusted to 0.16 mmol to synthesize Sn_{0.8}S catalyst.

The amount of SnCl₂ is adjusted to 0.14 mmol to synthesize Sn_{0.7}S catalyst.

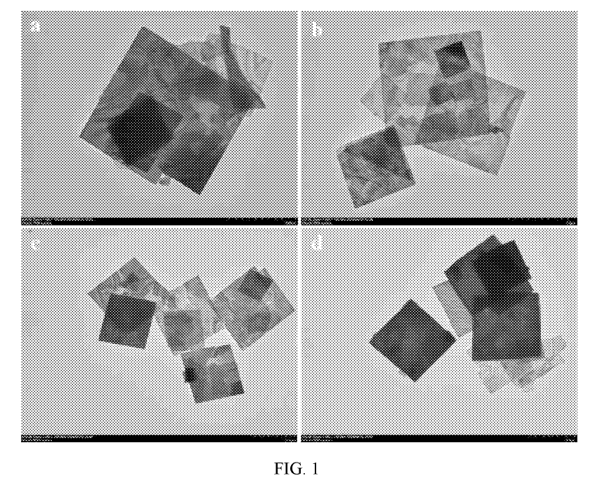

The Sn₁₋ₓS catalysts described in the embodiment 1 are characterized by scanning electron microscopy (SEM), as shown in FIG. 1, which illustrates morphology images of Sn₁₋ₓS catalysts with two-dimensional platelet structures. Specifically, in FIG. 1, a represents a morphology image of the SnS catalyst, b represents a morphology image of the Sn_{0.9}S catalyst, c represents a morphology image of the Sn_{0.8}S catalyst, and d represents a morphology image of the Sn_{0.7}S catalyst.

### 2. Catalytic performance of different Sn₁₋ₓS catalysts

Specifically, 1 g of each of the Sn₁₋ₓS catalysts are added to 1 L of deionized water, and then is subjected to ultrasonic treatment for 10 seconds, followed by continuously introducing oxygen into the deionized water to undergo a reaction (i.e., a catalytic reaction) in a water bath at a constant temperature of 30°C. Reaction solutions to the different Sn₁₋ₓS catalysts are sampled every 0.5 hours. An absorbance value of each of the sampled solutions is measured by using an ultraviolet (UV) spectrophotometer at a wavelength of 350 nm, and a hydrogen peroxide concentration of each of the sampled solutions is calculated based on a pre calibrated standard solution curve.

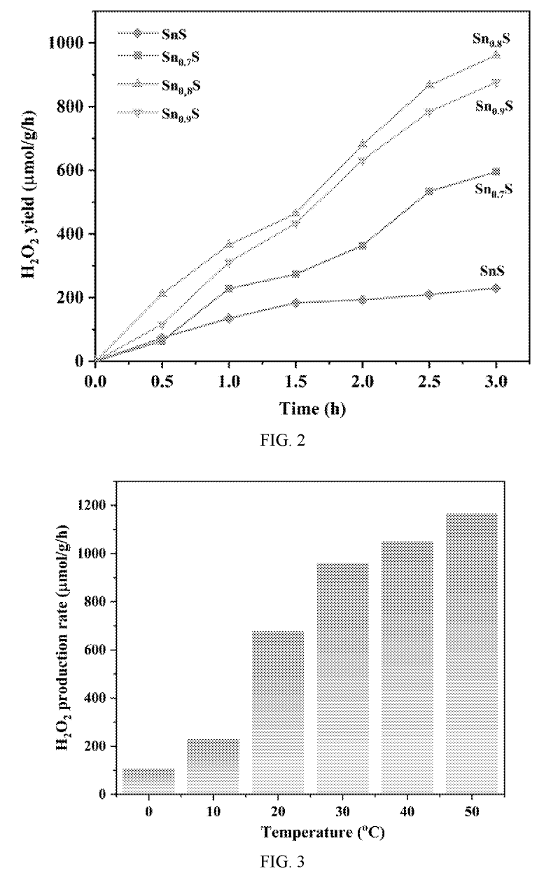

The catalytic performance for hydrogen peroxide production of the above Sn_{1−x}S catalysts are compared at a reaction temperature (i.e., a temperature of the reaction) of 30°C, and is shown in FIG. 2. Specifically, the Sn_{0.8}S catalyst exhibits the optimal performance, achieving a hydrogen peroxide production rate of 950 micromoles per gram per hour (μmol/g/h) after 3 hours of the catalytic reaction.

### 3. Catalytic performance of the Sn_{0.8}S catalyst at different temperatures

Specifically, 1 g of the Sn_{0.8}S catalyst is added to 1 L of deionized water, and then is subjected to ultrasonic treatment for 10 seconds, followed by continuously introducing oxygen into the deionized water. Catalytic experiments are respectively conducted in constant temperature water baths at 0°C, 10°C, 20°C, 30°C, 40°C, and 50°C, with reaction solutions respective to the Sn_{0.8}S catalyst at different temperatures sampled every 0.5 hours. An absorbance value of each of the sampled solutions is measured by using the UV spectrophotometer at the wavelength of 350 nm, and a hydrogen peroxide concentration of each of the sampled solutions is calculated based on the pre calibrated standard solution curve.

The Sn_{0.8}S catalyst, which exhibits the optimal performance in the embodiment 1, is further evaluated according to a scheme in the following embodiment 2. The catalytic performances for hydrogen peroxide production of the Sn_{0.8}S catalyst at different temperatures are compared, as shown in FIG. 3. Specifically, the catalytic performance is positively correlated with the catalytic reaction temperature. At the catalytic reaction temperature of 50°C, a catalytic reaction rate reaches 1180 μmol/g/h.

### Embodiment 2: catalytic experiments with different catalysts

### 1. Preparation of catalysts

SnS and SnS₂ Catalysts: SnS catalyst is prepared by using the same method as described in the embodiment 1. In addition, according to the preparation method of the catalysts Sn₁₋ₓS in the embodiment 1, while maintaining other steps unchanged, the amount of SnCl₂ is adjusted to 0.05 mmol to synthesize SnS₂ catalyst.

SnSe Catalyst: 5 mmol of selenium powder is dissolved in 5 mL of tri-n-octylphosphine (TOP) to form a transparent and uniform TOP-Se precursor solution. 0.5 mmol of SnCl₂ is dissolved in 40 mL of oleylamine to form a uniform solution. Then, this uniform solution is purged with nitrogen for 1 hour to remove dissolved oxygen, thereby obtaining a Sn precursor solution. 0.5 mL of the TOP-Se precursor solution is mixed with 2 mL of hexamethyldisilazane (HMDS) to obtain an HMDS-TOP-Se solution. The Sn precursor solution is heated to 240°C, and the HMDS-TOP-Se solution is rapidly injected into the Sn precursor solution to obtain a mixed solution. After the mixed solution turns black, it is aged for 30 minutes at 240°C under a nitrogen atmosphere, following by centrifugal separation to collect black powder SnSe.

SnTe Catalyst: 59.5 mg of tin acetate, 2 mL of oleic acid, and 0.5 mL of TOP are added sequentially to 10 mL of diphenyl ether to obtain a mixture. The mixture is stirred at 130°C for 5 minutes and then degassed under vacuum at 80°C for 1.5 hours. Under nitrogen protection, 0.15 mL of 1-chlorotetradecane is added to the above mixture after stirring and degassing to obtain a resulting solution, and then is heated to 210°C. After 10 minutes, 0.8 mL of TOP-Te precursor solution with a concentration of 0.65 moles per liter (mol/L) is rapidly injected into the resulting solution to make a color of the resulting solution gradually changes from transparent yellow to grayish-yellow. After 1 minute of reaction, heating is stopped, and toluene is added. The SnTe powders are obtained by centrifugal washing.

GeTe Catalyst: 67 mg of polyvinylpyrrolidone (PVP) and 50 mg of sodium oleate are dissolved in 250 mL of nonanoic acid solvent to obtain a mixed solution. The mixed solution is degassed under vacuum at 110°C. Then, under an argon atmosphere, this mixed solution is maintained at 110°C, and 120 mg of germanium bis(trimethylsilyl)amide (Ge[N(SiMe₃)₂]₂) is added into the mixed solution via a syringe to make a color of the mixed solution gradually changes from colorless to light yellow. Then, the solution is raised to 250℃ and 0.3 mL of TOP-Te precursor solution is injected. After 5 minutes, a dark brown colloidal dispersion liquid is formed. After aging for 20 minutes, this dark brown colloidal dispersion liquid is cooled and diluted with an equal volume of hexane, followed by centrifugal washing to collect GeTe powders.

PbTe Catalyst: 1 mmol of lead nitrate (Pb(NO₃)₂) and an appropriate amount of sodium hydroxide (NaOH) are dissolve in 15 mL of deionized water with magnetic stirring until completely dissolved to obtain a first uniform solution. Separately, 1 mmol of sodium tellurite (Na₂TeO₃) and 0.5 g of PVP are dissolved in 10 mL of deionized water with stirring to form a second uniform solution. Subsequently, the above two solutions (i.e., the first uniform solution and the second uniform solution) are mixed to obtain a mixed solution. Then, 10 mL of hydrazine hydrate (N₂H₄·H₂O) is added into the mixed solution and deionized water is added to a total volume of 40 mL, thereby obtaining a resulting mixture. The resulting mixture is stirred for 5 minutes and transferred to a 100 mL polytetrafluoroethylene (PTFE)-lined stainless steel autoclave. The autoclave is sealed and placed in an oven, which is kept at 160°C for 24 hours. After the reaction, the reaction solution is allowed to cool naturally to room temperature, and then is subjected to vacuum filtration to collect gray precipitate. The gray precipitate is washed sequentially with deionized water and anhydrous ethanol three times, respectively, and then dried in air at room temperature for 12 hours to obtain PbTe powders.

### 2. Catalytic performance experiment

1 g of each of the above-mentioned catalysts SnS, SnS₂, SnSe, SnTe, GeTe, and PbTe is taken and added to 1 L of deionized water, and then ultrasonicated for 10 seconds, followed by introducing oxygen into the deionized to undergo a reaction (i.e., a catalytic reaction) in a water bath at a constant temperature (i.e., 30°C). Then, reaction solutions respective to the above catalysts are taken every 0.5 hours. An absorbance of each of the sampled solutions is measured at the wavelength of 350 nm by using a UV spectrophotometer, and the hydrogen peroxide concentration is calculated based on the pre calibrated standard solution curve.

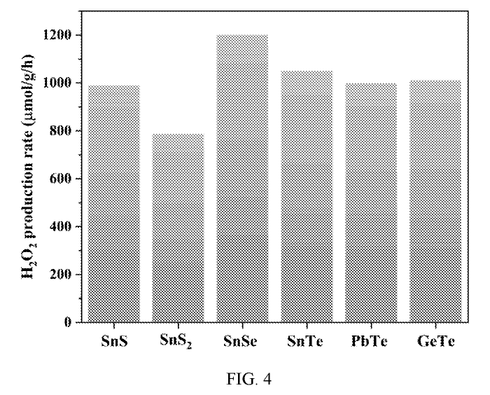

In the embodiment 2, the catalytic performances for hydrogen peroxide production of six defect-rich group IV-VI binary semiconductor materials (SnS, SnS₂, SnSe, SnTe, GeTe, PbTe) are compared at 30°C. As shown in FIG. 4, all six catalysts exhibit catalytic activity for hydrogen peroxide production. Specifically, the SnSe catalyst achieves a hydrogen peroxide production rate of 1200 μmol/g/h after 3 hours at 30°C.

Although the disclosure has been described based on specific embodiments, various modifications can be made and components can be replaced with equivalents without departing from the scope of the disclosure. It should be specifically pointed out that, as long as there is no structural contradiction, technical features mentioned in each embodiment can be combined in any form. The disclosure is not limited to the specific embodiments disclosed in this text but actually covers all technical solutions within the scope of the appended claims.

What is claimed is:

1. A method for synthesizing hydrogen peroxide, comprising:
dispersing a defect-rich group Ⅳ-Ⅵ binary semiconductor material as a catalyst in water, followed by stirring or ultrasonic dispersion, and then continuously introducing air or oxygen into the water to undergo a reaction at a constant temperature in a range of 0 to 80℃, thereby catalytically producing the hydrogen peroxide.

2. The method for synthesizing hydrogen peroxide as claimed in claim 1, wherein the defect-rich group Ⅳ-Ⅵ binary semiconductor material is one selected from the group consisting of Sn₁₋ₓSe, Sn₁₋ₓTe, Sn₁₋ₓS, Ge₁₋ₓTe, Ge₁₋ₓSe, Ge₁₋ₓS, Pb₁₋ₓSe, Pb₁₋ₓS, and Pb₁₋ₓTe, where x is 0 to 0.99.

3. The method for synthesizing hydrogen peroxide as claimed in claim 1, wherein a morphology of the catalyst is one or more of platelets, wires, particles, or porous structures, a size of the catalyst is in a range of 10 nanometers (nm) to 100 micrometers (µm), and a porosity of the catalyst is in a range of 0 to 60%.

4. The method for synthesizing hydrogen peroxide as claimed in claim 1, wherein a usage ratio of the catalyst to the water is (10 milligrams (mg)-1 gram (g)) : 1 liter (L).

5. The method for synthesizing hydrogen peroxide as claimed in claim 1, wherein the constant temperature of the reaction is in a range of 20℃ to 50℃.

6. The method for synthesizing hydrogen peroxide as claimed in claim 1, wherein the water comprises deionized water, seawater, domestic water, or natural water.
